(19) United States
(12) Patent Application Publication
(10) Pub. No.: US 2015/0070710 A1
(43) Pub. Date: Mar. 12, 2015

(54) MEASUREMENT APPARATUS

(71) Applicant: CANON KABUSHIKI KAISHA, Tokyo (JP)

(72) Inventor: Hiroshi OSAWA, Utsunomiya-shi (JP)

(21) Appl. No.: 14/476,261

(22) Filed: Sep. 3, 2014

(30) Foreign Application Priority Data
Sep. 6, 2013 (JP) 2013-185707

(51) Int. Cl. G01B 9/02; G01B 11/14; G01B 11/24

(52) U.S. Cl. CPC G01B 9/0207; G01B 11/2441; G01B 11/14
USPC 356/508

(57) ABSTRACT

The present invention provides a measurement apparatus which obtains a measurement value with respect to a measurement surface based on an interference signal obtained by causing measurement light reflected from the measurement surface and reference light reflected from a reference surface to interfere with each other, the apparatus including a measurement head including an interference optical system configured to generate the interference signal, and a processor configured to obtain a position of an alignment target on the measurement surface based on the interference signal, and obtain the measurement value based on the position of the alignment target and the interference signal.

### BACKGROUND OF THE INVENTION

1. Field of the Invention

The present invention relates to a measurement apparatus which obtains a measurement value regarding a measurement surface.

2. Description of the Related Art

The dimensions of the primary mirror of a telescope installed on the ground for astronomic observation are becoming larger to improve the performance of the telescope. For example, in the Subaru Telescope, a primary mirror formed from one mirror has a dimension of 8.2 m.

Recently, there has been proposed a telescope using, as a primary mirror, a composite mirror constituted by connecting a plurality of hexagonal mirrors (segment mirrors). For example, the primary mirror of the TMT (Thirty Meter Telescope) tries to implement an effective aperture of 30 m by using a composite mirror formed from 492 segment mirrors (hexagonal mirrors each having a circumscribed circle diameter of 1.5 m and a diagonal line length of 1.44 m).

To manufacture a segment mirror forming such a composite mirror at high precision, the shape (surface shape) of a substrate for forming the reflecting surface (mirror surface) needs to be accurately measured. For example, measurement of a segment mirror constituting the primary mirror of the TMT requires a measurement precision as high as about several nm RMS. As a technique of measuring the surface shape of such a large surface at a precision of about several nm RMS, Japanese Patent Laid-Open Nos. 2009-145095 and 11-173835 have proposed measurement apparatuses using a contact probe.

Near the summit of Mauna Kea in Hawaii where the installation of the TMT is assumed, the temperature becomes as low as about 2° C., which is different by about 20° C. from a room temperature of 23° C. at which a segment mirror is measured in general. It is therefore necessary to measure (the substrate of) a segment mirror at a low temperature of about 2° C., which is equal to the temperature near the summit of Mauna Kea, in consideration of a measurement error arising from thermal contraction of the substrate of a segment mirror, or thermal deformation of a substrate attachment jig used in measurement or the like.

Hence, there has been proposed a measurement apparatus using a non-contact probe in which a measurement object (segment mirror) is accommodated in a thermostatic chamber maintained at a low temperature of about 2° C., a light-transmissive window for transmitting light is arranged on the top surface of the thermostatic chamber, and the shape of the measurement object is measured through the light-transmissive window.

In the measurement apparatus, it is important to reduce a measurement error generated in accordance with the accuracy of the installation position when a measurement object such as the substrate of a segment mirror is installed in the measurement apparatus. When a measurement object is measured at a very high precision of about several nm RMS, a measurement error (setting error) arising from an error of the installation position of the measurement object with respect to the measurement probe is not negligible. Japanese Patent Laid-Open No. 11-173835 has disclosed a technique of reducing a setting error.

In Japanese Patent Laid-Open No. 11-173835, three spherical surfaces Tb, Tc, and Td indicating the installation position of a measurement object Ta are arranged on the surface of the measurement object Ta, as shown in FIG. 17. A contact probe CP scans the three spherical surfaces Tb, Tc, and Td arranged on the surface of the measurement object Ta to reduce an error of the installation position of the measurement object Ta with respect to the contact probe CP that causes a setting error.

However, with the technique in Japanese Patent Laid-Open No. 11-173835, it is difficult to perform high-precision alignment between the contact probe and a measurement object because the distal end shape of the contact probe is large and the spherical surface arranged on the surface of the measurement object is also large. As a result, it is difficult to measure the shape of a measurement object at a precision of about several nm RMS.

As described above, when measuring a measurement object arranged inside the thermostatic chamber, the contact probe is obstructed by the partition of the thermostatic chamber and cannot scan a spherical surface arranged on the measurement object. Hence, an error of the installation position of the measurement object with respect to the contact probe, which causes a setting error, cannot be reduced.

To the contrary, a measurement apparatus using a non-contact probe to measure the shape of a measurement object through a light-transmissive window arranged in a thermostatic chamber does not have an arrangement for reducing an error of the installation position of the measurement object arranged inside the thermostatic chamber. This measurement apparatus cannot reduce a setting error arising from an error of the installation position of a measurement object with respect to the non-contact probe. It is difficult to measure the shape of a measurement object at a precision of about several nm RMS.

### SUMMARY OF THE INVENTION

The present invention provides, for example, a measurement apparatus advantageous in terms of obtaining a measurement value regarding a measurement surface.

According to one aspect of the present invention, there is provided a measurement apparatus which obtains a measurement value with respect to a measurement surface based on an interference signal obtained by causing measurement light reflected from the measurement surface and reference light reflected from a reference surface to interfere with each other, the apparatus including a measurement head including an interference optical system configured to generate the interference signal, and a processor configured to obtain a position of an alignment target on the measurement surface based on the interference signal, and obtain the measurement value based on the position of the alignment target and the interference signal.

Further aspects of the present invention will become apparent from the following description of exemplary embodiments with reference to the attached drawings.

### BRIEF DESCRIPTION OF THE DRAWINGS

FIG. 1 is a schematic view showing the arrangement of a measurement apparatus according to the first embodiment of the present invention.

FIG. 2 is a schematic view showing the outer appearance of the measurement apparatus shown in FIG. 1.

FIG. 3 is a view for explaining alignment in the X-Y plane between an interference optical system and a measurement surface.

FIGS. 4A to 4D are views for explaining alignment in the X-Y plane between the interference optical system and the measurement surface.

FIG. 5 is a view showing an alignment mark formed on the measurement surface.

FIG. 6 is a schematic view showing the arrangement of a measurement apparatus according to the second embodiment of the present invention.

FIG. 7 is a schematic view showing the arrangement of a measurement apparatus according to the third embodiment of the present invention.

FIG. 8 is a view for explaining alignment between a condensed beam and alignment marks respectively formed on a measurement surface and light-transmissive window.

FIGS. 9A and 9B are views showing alignment marks respectively formed on the light-transmissive window and measurement surface.

FIG. 10 is a schematic view showing the arrangement of a measurement apparatus according to the fourth embodiment of the present invention.

FIG. 11 is a schematic view showing the arrangement of the light-transmissive window of the measurement apparatus shown in FIG. 10.

FIGS. 12A and 12B are views showing alignment marks respectively formed on the first light-transmissive window and measurement surface.

FIG. 13 is a schematic view showing the arrangement of a measurement apparatus according to the fifth embodiment of the present invention.

FIG. 14 is a view for explaining alignment between an interference optical system and an alignment mark formed on a measurement surface.

FIGS. 15A and 15B are views for explaining alignment between the interference optical system and the alignment mark formed on the measurement surface.

FIG. 16 is a view showing the alignment mark formed on the measurement surface.

FIG. 17 is a schematic view showing the arrangement of a conventional measurement apparatus.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

### First Embodiment

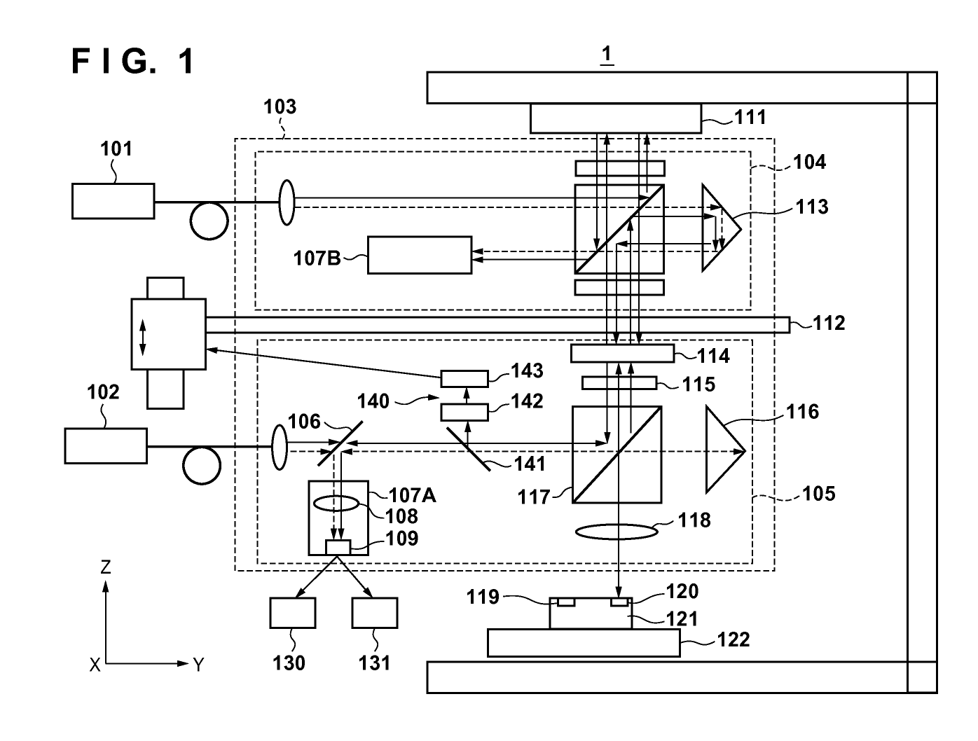

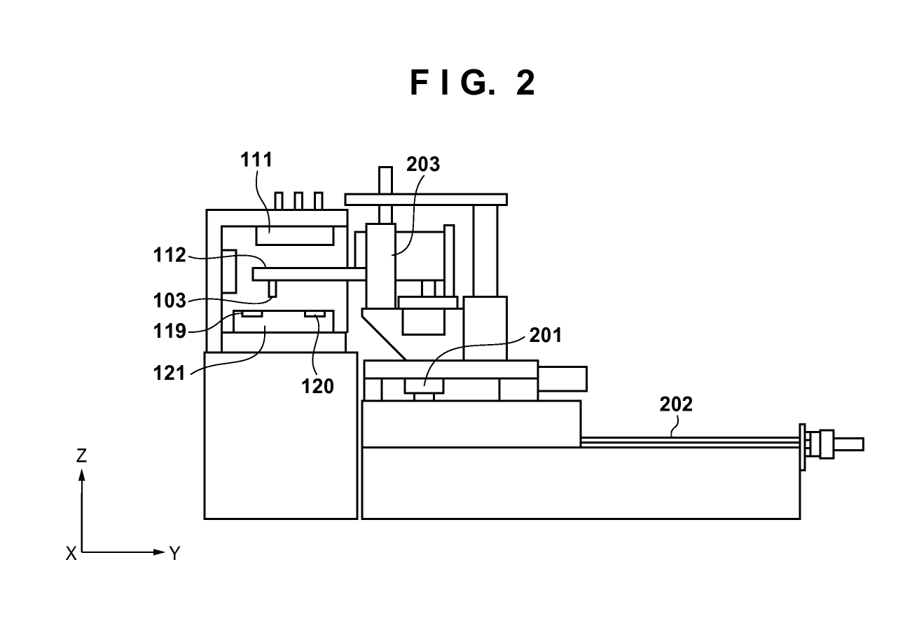

FIG. 1 is a schematic view showing the arrangement of a measurement apparatus 1 according to the first embodiment of the present invention. FIG. 2 is a schematic view showing the outer appearance of the measurement apparatus 1. The measurement apparatus 1 has a function of measuring a change of the optical path length of measurement light reflected by a measurement surface (object surface). In the first embodiment, the measurement apparatus 1 is embodied as a three-dimensional shape measurement apparatus including a non-contact probe (measurement head) using a heterodyne interference method. The measurement apparatus 1 obtains a measurement value regarding a measurement surface (for example, a measurement value regarding the shape of a measurement surface) from an interference signal generated by an interference optical system. The measurement apparatus 1 is suited to measurement of, for example, the shape of a measurement surface having a curvature and a circumscribed circle diameter of more than 1 m (for example, the surface shape of a segment mirror constituting a composite mirror usable as the primary mirror of a telescope, or the surface shape of the substrate of the segment mirror).

The measurement apparatus 1 includes, as main components, a light source 102, stage 112, reference mirror 111, interference optical system 103, autofocus system 140, detector 107A, first processor 130, and second processor 131. The interference optical system 103 is mainly constituted by an interference optical system 104 and interference optical system 105. In the measurement apparatus 1, the interference optical system 103 functions as a non-contact probe (optical probe).

A light source 101 and the light source 102 emit two beams having different wavelengths and different directions of polarization, for example, S-polarized light and P-polarized light having directions of polarization perpendicular to each other in the embodiment. As the light sources 101 and 102, He—Ne lasers having a wavelength of 663 nm are generally used. Lights (parallel lights) emitted by the light sources 101 and 102 are used at a diameter of about 6 mm. An optical fiber, mirror, and the like may be interposed between a subsequent polarizing beam splitter and each of the light sources 101 and 102.

Light emitted by the light source 101 enters the polarizing beam splitter of the interference optical system 104 held by the stage 112. The polarizing beam splitter is configured to reflect S-polarized light and transmit P-polarized light. Light emitted by the light source 101 is used to obtain a change of the optical path length of the first measurement light reflected by the reference mirror 111 and a double-sided mirror 114. The light passes through the polarizing beam splitter, a corner cube 113 serving as a reference surface, and the like, and is detected by a detector 107B.

Light emitted by the light source 102 enters a polarizing beam splitter 117 of the interference optical system 105 held by the stage 112. The interference optical system 105 is an optical system which splits light emitted by the light source 102 into two lights, causes one light to enter a measurement surface 121 through the double-sided mirror 114 and a condenser lens 118, causes the other light to enter the reference surface, and causes the light reflected by the measurement surface 121 and the light reflected by the reference surface to interfere with each other. In the embodiment, a corner cube 116 serves as the reference surface.

Light emitted by the light source 102 is used to obtain a change of the optical path length of the second measurement light reflected by the double-sided mirror 114 and measurement surface 121. Although lights emitted by the light sources 101 and 102 are illustrated to be parallel to the Y- or Z-axis in FIG. 1, they contain a slight inclination error in practice.

The measurement apparatus 1 obtains a change of the optical path length of the first measurement light and a change of the optical path length of the second measurement light by using the interference optical system 103 including the interference optical system 104 serving as a double-pass optical system and the interference optical system 105 serving as a single-pass optical system. The measurement apparatus 1 can therefore measure the shape of the measurement surface 121 at high precision.

As shown in FIG. 2, the stage 112 is driven in the X-Y plane by an X-axis driving unit 201 and Y-axis driving unit 202. The stage 112 is driven in the Y-Z plane by the Y-axis driving unit 202 and a Z-axis driving unit 203. The X-axis driving unit 201, Y-axis driving unit 202, and Z-axis driving unit 203 function as a positioning mechanism which positions the stage 112 holding the interference optical system 103.

The polarizing beam splitter 117 is configured to reflect S-polarized light and transmit P-polarized light. Of light emitted by the light source 102, S-polarized light is reflected by the polarizing beam splitter 117, becomes light almost parallel to the Z-axis, and enters a λ/4 plate 115. Of the light emitted by the light source 102, P-polarized light passes through the polarizing beam splitter 117, becomes light almost parallel to the Y-axis, and enters the corner cube 116 serving as a reference surface.

The light (measurement light) entering the λ/4 plate 115 passes through the λ/4 plate 115, becomes circularly polarized light, and is reflected by the double-sided mirror 114. The light reflected by the double-sided mirror 114 passes again through the λ/4 plate 115, becomes P-polarized light, passes through the polarizing beam splitter 117, and is condensed through the condenser lens 118 on the measurement surface 121 held on a measurement stage 122 (is focused on the measurement surface 121). The autofocus system 140 is used to focus measurement light on the measurement surface 121.

The autofocus system 140 will be explained together with a method of condensing measurement light on the measurement surface 121. In the measurement apparatus 1, the autofocus system (adjustment unit) 140 controls a position of the condenser lens 118 in a direction along the optical axis. More specifically, the autofocus system 140 adjusts (controls) the distance between the condenser lens 118 and the measurement surface 121 so that a measurement portion on the measurement surface 121 falls (is positioned) within the range of the depth of focus of the condenser lens 118.

The autofocus system 140 includes, for example, a measurement unit 142 and focus control unit 143. The autofocus system 140 controls the position of the condenser lens 118 in the direction along the optical axis of the condenser lens 118 by using the stage 112 holding the interference optical system 103, and the Z-axis driving unit 203. The measurement unit 142 measures a position (the focus state of light condensed by the condenser lens 118) of the condenser lens 118 in the direction along the optical axis. Based on the measurement result (focus state) of the measurement unit 142, the focus control unit 143 controls driving of the stage 112 by the Z-axis driving unit 203 so that a measurement portion on the measurement surface 121 falls within the range of the depth of focus of the condenser lens 118. Since the Z-axis driving unit 203 is a driving unit which drives the stage 112 in the Z-axis direction, as described above, it can move, in the direction along the optical axis of the condenser lens 118, the condenser lens 118 of the interference optical system 103 held by the stage 112.

An example of the arrangement of the measurement unit 142 will be explained. When light condensed by the condenser lens 118 falls outside the range of the depth of focus of the condenser lens 118, light which has been reflected by the measurement surface 121 and has passed again through the condenser lens 118 does not become parallel light, but converges or diverges. In consideration of this, the measurement unit 142 is constituted by a cylindrical lens and four-division sensor. The measurement unit 142 can measure a focus state by causing light reflected by the measurement surface 121 to enter the measurement unit 142 through a half mirror 141. Note that the half mirror 141 is an optical component which splits, at an appropriate ratio, light (transmission light) passing through the half mirror 141 and light (reflected light) reflected by the half mirror 141. The half mirror 141 is not limited to an optical component which splits transmission light and reflected light at 50%. In this manner, the measurement unit 142 can measure a focus state by using light which is reflected by the measurement surface 121, enters again the condenser lens 118, and returns to the optical system including the polarizing beam splitter 117.

For example, Japanese Patent Laid-Open No. 2012-165139 has disclosed a measurement apparatus including a non-contact probe constituted by combining the interference optical system of a double-pass optical system and the interference optical system of a single-pass optical system.

As a main feature of the embodiment, alignment marks 119 and 120 are formed as alignment targets on the upper surface of the measurement surface 121. In the measurement apparatus 1, the autofocus system 140 can adjust measurement portions on the measurement surface 121 to fall within the range of the depth of focus of the condenser lens 118. By using the autofocus system 140, the measurement apparatus 1 can irradiate the alignment marks 119 and 120 on the measurement surface 121 with light condensed by the condenser lens 118 (can cause the light to be incident on the alignment marks 119 and 120).

As described above, in the measurement apparatus 1, measurement portions on the measurement surface 121 are adjusted to fall within the range of the depth of focus of the condenser lens 118. Light (measurement light) reflected by the measurement surface 121 passes again through the condenser lens 118, becomes parallel light, passes through the polarizing beam splitter 117, and enters the λ/4 plate 115.

The measurement light which has passed through the λ/4 plate 115 and is reflected by the double-sided mirror 114 passes again through the λ/4 plate 115, and becomes S-polarized light. The measurement light having passed through the λ/4 plate 115 is reflected by the polarizing beam splitter 117 and a half mirror 106, and enters the detector 107A constituted by a lens 108 and photodiode 109. Note that the half mirror 106 is an optical component which splits, at an appropriate ratio, light (transmission light) passing through the half mirror 106 and light (reflected light) reflected by the half mirror 106. The half mirror 106 is not limited to an optical component which splits transmission light and reflected light at 50%.

Light entering the corner cube 116 is reflected in the incident direction by the corner cube 116. The light (reference light) which has been reflected by the corner cube 116 and has entered again the polarizing beam splitter 117 passes through the polarizing beam splitter 117, and is reflected by the half mirror 106 together with measurement light reflected by the polarizing beam splitter 117. The measurement light and reference light reflected by the half mirror 106 enter the detector 107A constituted by the lens 108 and photodiode 109.

The detector 107A detects interference light between the measurement light and the reference light, and acquires an interference signal corresponding to the interference light, for example, a heterodyne interference signal in the embodiment. In the measurement apparatus 1, the first processor 130 obtains a change of the light amount of measurement light, or signal light serving as a combination of measurement light and reference light, based on the light amount signal (intensity) of the heterodyne interference signal detected by the detector 107A. The second processor 131 obtains a change of the optical path length of measurement light based on phase information of the heterodyne interference signal detected by the detector 107A.

In the measurement apparatus 1, the first processor 130 acquires light amount information of the heterodyne interference signal while the X-axis driving unit 201 and Y-axis driving unit 202 shown in FIG. 2 drive the stage 112 in the X-Y plane. In other words, the first processor 130 acquires light amount information of the heterodyne interference signal while the interference optical system 103 is positioned so that light traveling from the interference optical system 105, that is, light condensed by the condenser lens 118 enters a plurality of positions (measurement portions) on the measurement surface 121. A change of the light amount of measurement light is obtained based on the light amount information of the heterodyne interference signal that is acquired by the first processor 130. Accordingly, the positions (shapes) of the alignment marks 119 and 120 formed on the upper surface of the measurement surface 121 can be measured at high precision.

Also, in the measurement apparatus 1, the second processor 131 acquires phase information of the heterodyne interference signal while the X-axis driving unit 201 and Y-axis driving unit 202 drive the stage 112 in the X-Y plane. In other words, the second processor 131 acquires phase information of the heterodyne interference signal while the interference optical system 103 is positioned so that light traveling from the interference optical system 105, that is, light condensed by the condenser lens 118 enters a plurality of positions (measurement portions) on the measurement surface 121. A change of the optical path length of measurement light is obtained based on the phase information of the heterodyne interference signal that is acquired by the second processor 131, thereby measuring the shape of the measurement surface 121 (obtaining a measurement value).

The embodiment has explained, as the interference optical system 103, a non-contact probe using the heterodyne interference method. However, the interference optical system 103 may be a non-contact probe using a homodyne interference method. The measurement apparatus 1 according to the embodiment obtains a change of the light amount of measurement light and a change of the optical path length by acquiring an interference signal by the detector 107A while moving the stage 112 in the X-Y plane. The measurement apparatus 1 can therefore measure not only the surface shape of an object, but also the characteristics of the object that are correlated with these changes. The measurement apparatus 1 can measure, for example, even the surface roughness of the object.

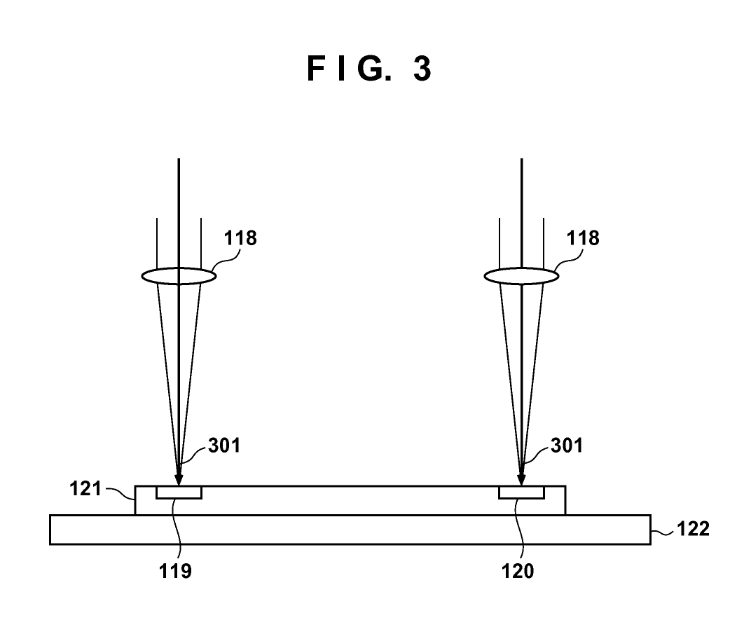

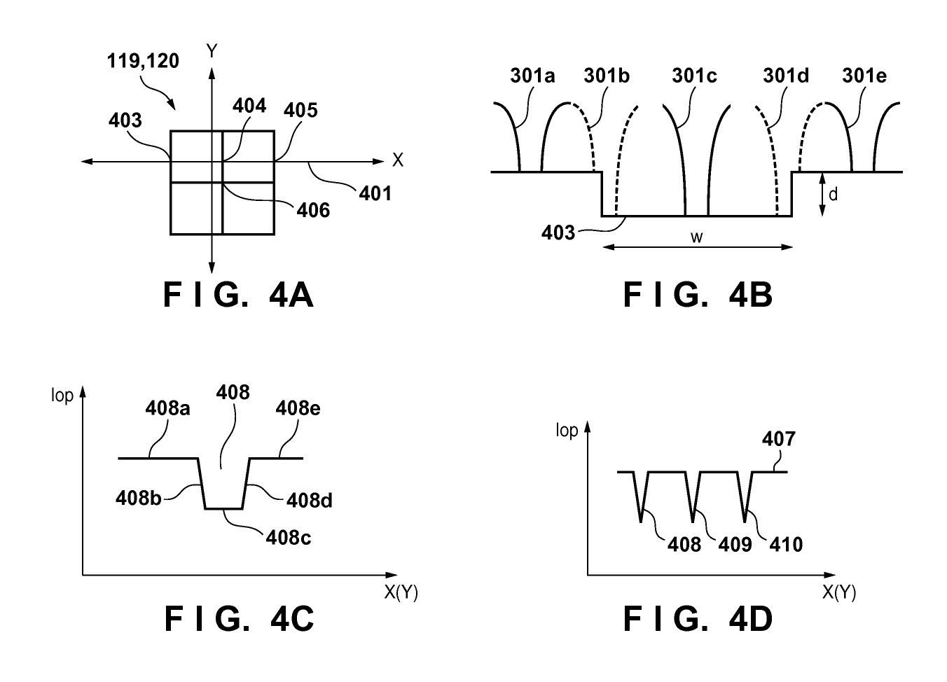

Alignment in the X-Y plane (measurement plane) between the interference optical system 103 including the condenser lens 118 and the measurement surface 121 on which the alignment marks 119 and 120 are formed will be explained with reference to FIGS. 3 and 4A to 4D. As shown in FIG. 3, the condenser lens 118 constituting the interference optical system 103 condenses measurement light to form a condensed beam 301. By moving the interference optical system 103 in the X-Y plane, each of the alignment marks 119 and 120 formed on the measurement surface 121 can be irradiated with the condensed beam 301 (the condensed beam 301 can be incident on each alignment mark). The spot size (diameter) of the condensed beam 301 can be narrowed down to a diameter of about 10 μm to 100 μm though it depends on the optical design of the condenser lens 118.

In the measurement apparatus 1, the autofocus system 140 can control the position of the condenser lens 118 in the optical axis direction so that the alignment marks 119 and 120 on the measurement surface 121 fall within the range of the depth of focus of the condenser lens 118. By moving the interference optical system 103 in the X-Y plane including the X-axis and Y-axis, the condensed beam 301 condensed by the condenser lens 118 can move to an arbitrary position in the X-Y plane.

FIG. 4A is a schematic view showing an example of the shape of the alignment mark 119. Since the alignment marks 119 and 120 have the same composition, the alignment mark 119 will be exemplified here. The alignment mark 119 is a 2×2-matrix mark having a rectangular outer frame, and a cross shape arranged inside the outer frame. The alignment mark 119 includes three vertical lines 403, 404, and 405 in the Y-axis direction, and three horizontal lines in the X-axis direction. As shown in FIG. 4B, a line in each of the X-axis direction and Y-axis direction is formed at a width w and a depth d on the measurement surface 121 serving as a quartz substrate. FIG. 4B is a schematic view showing the section of the vertical line 403 of the alignment mark 119. The alignment mark 119 is constituted so that, for example, the rectangular outer frame is 1 mm square, the width w of a line in each of the X-axis direction and Y-axis direction is 100 μm, and the depth is about 158 nm which is equivalent to λ/4. However, the alignment mark 119 is not limited to the above-described shape as long as the first processor 130 can satisfactorily obtain the light amount signal of a heterodyne interference signal in accordance with the shape of the alignment mark 119. In other words, it is only necessary to satisfactorily obtain the position of the alignment mark 119 with respect to a reference position from the light amount signal of a heterodyne interference signal.

FIG. 4B shows even a state in which the interference optical system 103 moves in the X-axis direction to move the condensed beam 301 condensed by the condenser lens 118 on (the vertical line 403 of) the alignment mark 119 formed on the measurement surface 121. As described above, in the interference optical system 103, the autofocus system 140 controls the position of the condenser lens 118 in the optical axis direction so that the alignment marks 119 and 120 on the measurement surface 121 always fall within the range of the depth of focus of the condenser lens 118.

A case in which the condensed beam 301 condensed by the condenser lens 118 is moved in the X-axis direction or Y-axis direction will be explained. FIG. 4B shows condensed spots 301a, 301b, 301c, 301d, and 301e when the condensed beam 301 moves in the X-axis direction on the vertical line 403 of the alignment mark 119. FIG. 4C shows a light amount distribution (light amount information) 408 of heterodyne interference signals corresponding to the respective condensed spots 301a to 301e. Referring to FIG. 4C, light amounts 408a, 408b, 408c, 408d, and 408e correspond to the condensed spots 301a, 301b, 301c, 301d, and 301e, respectively. In FIG. 4C, the abscissa represents the position of the condensed beam 301 in the X-axis direction (or Y-axis direction) near the alignment mark 119, and the ordinate represents a light amount Iop of the heterodyne interference signal.

For example, the spot size of the condensed beam 301 is 10 μm, the width w of the vertical line 403 of the alignment mark 119 is 5 μm, and the depth d is 158 nm which is equivalent to λ/4 of 633 nm of the He—Ne laser serving as a representative wavelength of measurement light. Also, the light amounts of heterodyne interference signals near the vertical lines 403, 404, and 405 of the alignment mark 119 are light amounts 408, 409, and 410, as shown in FIG. 4D. In FIG. 4D, the abscissa represents the position of the condensed beam 301 in the X-axis direction (or Y-axis direction) near the alignment mark 119, and the ordinate represents the light amount Iop of the heterodyne interference signal.

As shown in FIGS. 4C and 4D, the measurement apparatus 1 can obtain the satisfactory light amounts 408, 409, and 410 corresponding to the vertical lines 403, 404, and 405 of the alignment mark 119, respectively. When the condensed beam 301 moves in, for example, the X-axis direction on the alignment mark 119, a light amount distribution (light amount information) 407 which represents a position of the alignment mark 119 in the X-axis direction at high precision and includes the light amounts 408, 409, and 410 can be acquired. Similarly, by moving the condensed beam 301 in the Y-axis direction on the alignment mark 119, a light amount distribution (light amount information) which represents a position of the alignment mark 119 in the Y-axis direction at high precision can be acquired.

Based on the obtained positions of the alignment mark 119 in the X-axis direction and Y-axis direction, the positional relationship in the X-Y plane between a center position 406 of the alignment mark 119 and the condensed beam 301 can be obtained at high precision. By optimally adjusting design values such as the spot size of the condensed beam 301 and the width w and depth d of the vertical line 403 of the alignment mark 119, the light amount distribution 408 shown in FIG. 4C can become a light amount distribution with a higher contrast.

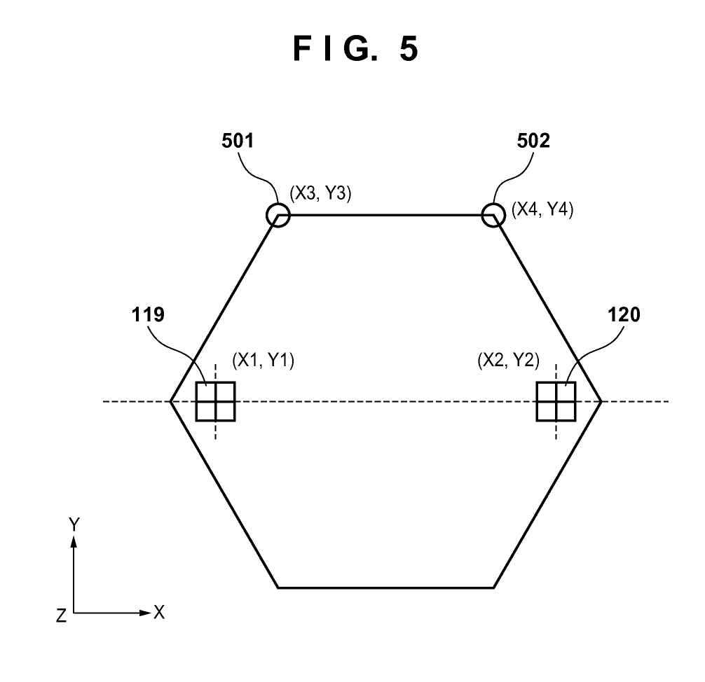

Further, in the measurement apparatus 1, the center positions of alignment marks formed on the measurement surface 121, that is, the center positions of the two alignment marks 119 and 120 are known on the measurement surface 121. Thus, the relative positional relationship between the measurement surface 121 and the condensed beam 301, or the relative positional relationship between the measurement surface 121 and the interference optical system 103 including the condenser lens 118 can be obtained at a high precision of about several μm on the entire measurement surface 121. More specifically, the position coordinates (X1, Y1) and (X2, Y2) of the two alignment marks 119 and 120 on the measurement surface 121 are known, as shown in FIG. 5. The relative positional relationship between the interference optical system 103 including the condenser lens 118 and the positions of the two alignment marks 119 and 120 is known. Therefore, the condensed beam 301 traveling from the interference optical system 103 can be moved to an arbitrary position on the measurement surface 121 at a high precision of about several μm.

Since the interference optical system 103 and measurement surface 121 can be aligned at a high precision of about several μm, a measurement error, that is, a setting error arising from an error of the installation position of the measurement surface 121 with respect to the interference optical system 103 can be reduced. For example, as correction processing when obtaining the shape of the measurement surface 121, alignment between measurement light and the alignment marks 119 and 120 is performed based on a positional shift on the measurement surface between measurement light and the alignment marks 119 and 120. The shape of the measurement surface 121 is obtained based on a heterodyne interference signal acquired after performing the alignment. The measurement apparatus 1 can greatly suppress a setting error and measure the shape of the measurement surface 121 at a high precision of about several nm RMS.

It is also possible to obtain the shape of the measurement surface 121 based on a heterodyne interference signal and remove, from the obtained result, an error arising from a positional shift on the measurement surface between measurement light and the alignment marks 119 and 120. In other words, it is also possible to estimate a setting error from a relative positional shift between the interference optical system 103 and the measurement surface 121, and perform numerical correction, thereby removing a setting error. In this case, it is necessary to grasp a setting error generated in accordance with a relative positional shift between the interference optical system 103 and the measurement surface 121 by performing measurement and numerical simulation in advance. However, a setting error can be suppressed to obtain the shape of the measurement surface 121 at high precision without performing alignment between the interference optical system 103 and the measurement surface 121 based on a relative positional shift between the interference optical system 103 and the measurement surface 121.

When removing a setting error by performing numerical correction, a relative positional shift between the interference optical system 103 and the measurement surface 121 may be obtained after obtaining the shape of the measurement surface 121.

As shown in FIG. 5, two edge portions 501 and 502 positioned respectively at position coordinates (X3, Y3) and (X4, Y4) on the measurement surface 121 may be used instead of the alignment marks 119 and 120. By obtaining the positional relationship between the interference optical system 103 including the condenser lens 118 and the positions of the edge portions 501 and 502 of the measurement surface 121, the condensed beam 301 traveling from the interference optical system 103 can be moved to an arbitrary position on the measurement surface 121 at a high precision of about several μm.

### Second Embodiment

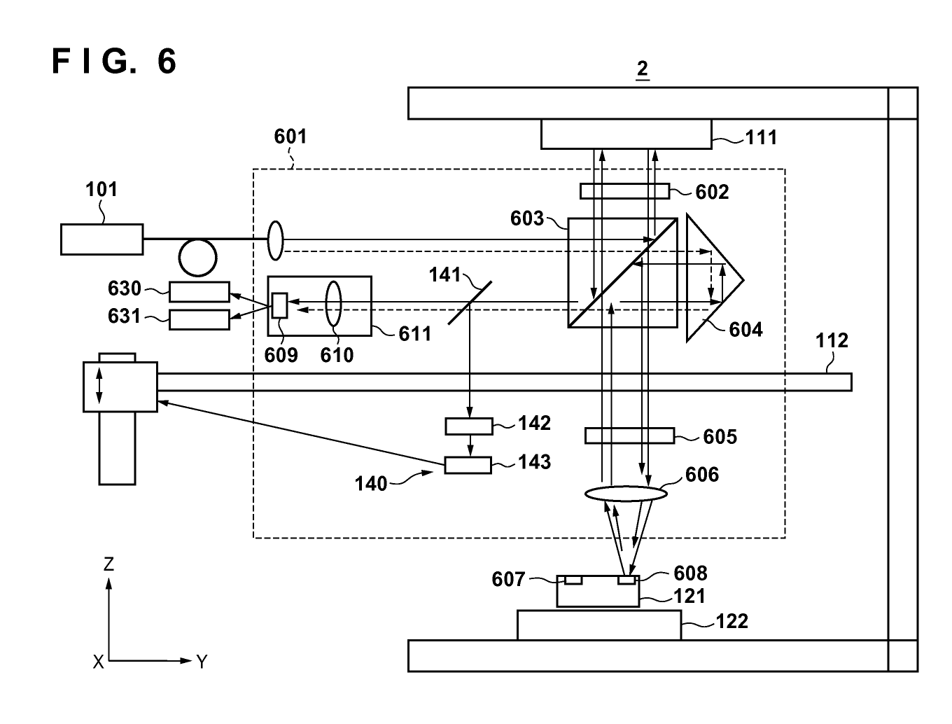

FIG. 6 is a schematic view showing the arrangement of a measurement apparatus 2 according to the second embodiment of the present invention. Similarly to the measurement apparatus 1, the measurement apparatus 2 has a function of measuring a change of the optical path length of measurement light reflected by a measurement surface. In the second embodiment, the measurement apparatus 2 is embodied as a three-dimensional shape measurement apparatus including a non-contact probe (measurement head) using a heterodyne interference method.

The measurement apparatus 2 includes, as main components, a light source 101, stage 112, reference mirror 111, interference optical system 601, autofocus system 140, detector 611, first processor 630, and second processor 631. In the second embodiment, the interference optical system 601 constitutes a double-pass heterodyne interference system in which light emitted by the light source 101 reciprocates twice between a measurement surface 121 and the reference mirror 111. In the measurement apparatus 2, the interference optical system 601 functions as a non-contact probe (optical probe). As in the first embodiment, alignment marks 607 and 608 are formed as alignment targets on the upper surface of the measurement surface 121.

Light (parallel light) emitted by the light source 101 enters a polarizing beam splitter 603 of the interference optical system 601 held by the stage 112. The light source 101 emits two lights having different wavelengths and different directions of polarization, that is, S-polarized light and P-polarized light having directions of polarization perpendicular to each other in the embodiment. The polarizing beam splitter 603 is configured to reflect S-polarized light and transmit P-polarized light. Of light emitted by the light source 101, S-polarized light is reflected by the polarizing beam splitter 603, becomes light almost parallel to the Z-axis, and enters a λ/4 plate 602. Of the light emitted by the light source 101, P-polarized light passes through the polarizing beam splitter 603, becomes light almost parallel to the Y-axis, and enters a corner cube 604 serving as a reference surface.

The light entering the λ/4 plate 602 passes through the λ/4 plate 602, becomes circularly polarized light, and is reflected by the reference mirror (reference surface) 111. The light reflected by the reference mirror 111 passes again through the λ/4 plate 602, becomes P-polarized light, passes through the polarizing beam splitter 603, and enters a λ/4 plate 605. The light entering the λ/4 plate 605 passes through the λ/4 plate 605, becomes circularly polarized light, and is condensed through a condenser lens 606 on the measurement surface 121 held by a measurement stage 122 (is focused on the measurement surface 121). The autofocus system 140 is used to focus measurement light on the measurement surface 121.

The light reflected by the measurement surface 121 passes through the condenser lens 606, becomes parallel light, and enters the λ/4 plate 605. The light entering the λ/4 plate 605 passes through the λ/4 plate 605, becomes S-polarized light, is reflected by the polarizing beam splitter 603, and enters the corner cube 604. The light reflected by the corner cube 604 is reflected by the polarizing beam splitter 603, and is condensed again on the measurement surface 121 through the λ/4 plate 605 and condenser lens 606. The light reflected by the measurement surface 121 passes through the condenser lens 606, becomes parallel light, and enters the λ/4 plate 605. In the following description, light reflected twice by the measurement surface 121 will be called measurement light. The measurement light entering the λ/4 plate 605 passes through the λ/4 plate 605, becomes P-polarized light, passes through the polarizing beam splitter 603, and enters the λ/4 plate 602. The light entering the λ/4 plate 602 passes through the λ/4 plate 602, becomes circularly polarized light, and is reflected by the reference mirror (reference surface) 111. The light reflected by the reference mirror 111 passes again through the λ/4 plate 602, becomes S-polarized light, is reflected by the polarizing beam splitter 603, and enters the detector 611 constituted by a lens 610 and photodiode 609.

Light entering the corner cube 604 is reflected in the incident direction by the corner cube 604, and enters the polarizing beam splitter 603. In the following description, light reflected by the corner cube 604 without being reflected by the measurement surface 121 will be called reference light. The reference light entering the polarizing beam splitter 603 passes through the polarizing beam splitter 603, and enters the detector 611 together with measurement light reflected by the polarizing beam splitter 603. The detector 611 detects interference light between the measurement light and the reference light, and acquires an interference signal corresponding to the interference light, for example, a heterodyne interference signal in the embodiment.

In the measurement apparatus 2, the first processor 630 obtains a change of the light amount of measurement light based on the light amount signal (intensity) of the heterodyne interference signal detected by the detector 611. The second processor 631 obtains a change of the optical path length of measurement light based on phase information of the heterodyne interference signal detected by the detector 611.

In the measurement apparatus 2, the first processor 630 acquires light amount information of the heterodyne interference signal while an X-axis driving unit 201 and Y-axis driving unit 202 drive the stage 112 in the X-Y plane. In other words, the first processor 630 acquires light amount information of the heterodyne interference signal while the interference optical system 601 is positioned so that light traveling from the interference optical system 601, that is, light condensed by the condenser lens 606 enters a plurality of positions (measurement portions) on the measurement surface 121. A change of the light amount of measurement light is obtained based on the light amount information of the heterodyne interference signal that is acquired by the first processor 630. Accordingly, the positions (shapes) of the alignment marks 607 and 608 formed on the upper surface of the measurement surface 121 are measured at high precision.

Also, in the measurement apparatus 2, the second processor 631 acquires phase information of the heterodyne interference signal while the X-axis driving unit 201 and Y-axis driving unit 202 drive the stage 112 in the X-Y plane. In other words, the second processor 631 acquires phase information of the heterodyne interference signal while the interference optical system 601 is positioned so that light traveling from the interference optical system 601, that is, light condensed by the condenser lens 606 enters a plurality of positions (measurement portions) on the measurement surface 121. A change of the optical path length of measurement light is obtained based on the phase information of the heterodyne interference signal that is acquired by the second processor 631, thereby measuring the shape of the measurement surface 121.

Even in the measurement apparatus 2, as in the measurement apparatus 1, a position of the condenser lens 606 in the optical axis direction is controlled so that a measurement portion on the measurement surface 121 falls (is positioned) within the range of the depth of focus of the condenser lens 606. Light (measurement light) which has been reflected by the measurement surface 121 and has entered the condenser lens 606 is reflected as parallel light by the polarizing beam splitter 603, and detected by the detector 611 together with light (reference light) reflected by the corner cube 604. The detector 611 therefore detects a satisfactory heterodyne signal. In this manner, even when the interference optical system 601 is constituted by a double-pass heterodyne interference system, the shape of the measurement surface 121 can be measured at high precision. More specifically, the measurement apparatus 2 can measure the shape of the measurement surface 121 at high precision by acquiring a heterodyne interference signal by the detector 611 while moving in the X-Y plane the stage 112 holding the interference optical system 601.

The measurement apparatus 2 according to the embodiment obtains a change of the light amount of measurement light and a change of the optical path length by acquiring an interference signal by the detector 611 while moving the stage 112 in the X-Y plane. The measurement apparatus 2 can measure not only the surface shape of an object, but also the characteristics of the object that are correlated with these changes. The measurement apparatus 2 can measure, for example, even the surface roughness of the object.

Alignment in the X-Y plane (measurement plane) between the interference optical system 601 including the condenser lens 606 and the measurement surface 121 on which the alignment marks 607 and 608 are formed will be explained. Each of the alignment marks 607 and 608 is a 2×2-matrix mark having a rectangular outer frame, and a cross shape arranged inside the outer frame. In the embodiment, light condensed by the condenser lens 606 is scanned in the X-axis direction and Y-axis direction on the alignment marks 607 and 608. The autofocus system 140 is used when condensing measurement light on the measurement surface 121. Based on a change of light amount information of a heterodyne interference signal, the first processor 630 measures at high precision the relative positions of the interference optical system 601 and the alignment marks 607 and 608 formed on the measurement surface 121.

Even in the measurement apparatus 2 using a double-pass optical system, the interference optical system 601 and measurement surface 121 can be aligned at a high precision of about several μm, as in the measurement apparatus 1 using a single-pass optical system. Accordingly, a measurement error, that is, a setting error arising from an error of the installation position of the measurement surface 121 with respect to the interference optical system 601 can be reduced. Similarly to the measurement apparatus 1, the measurement apparatus 2 can greatly suppress a setting error and measure the shape of the measurement surface 121 at a high precision of about several nm RMS.

### Third Embodiment

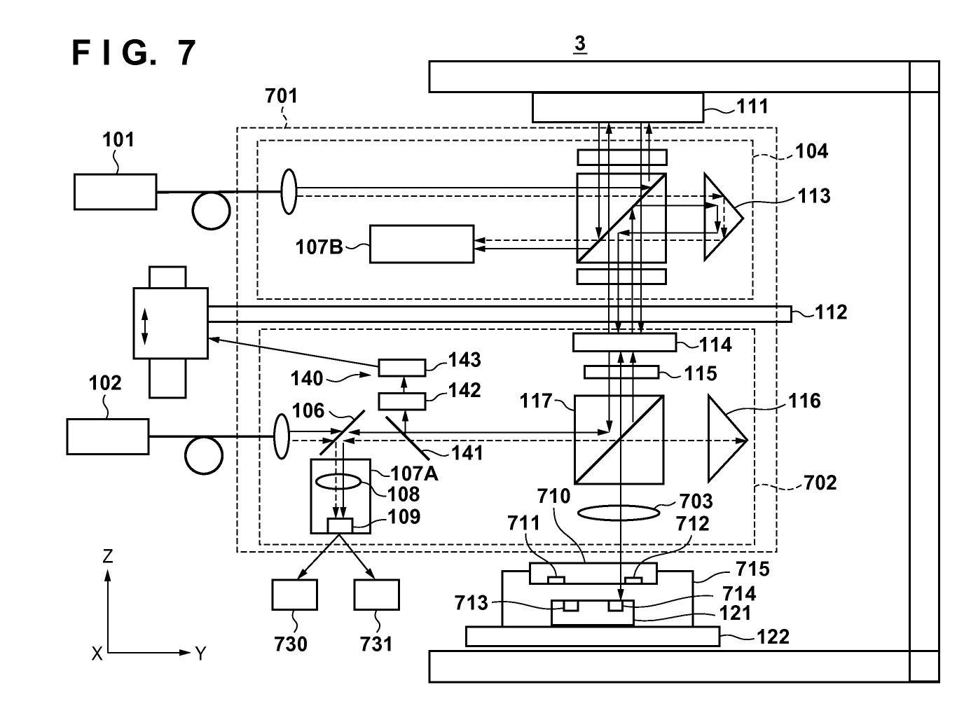

FIG. 7 is a schematic view showing the arrangement of a measurement apparatus 3 according to the third embodiment of the present invention. The measurement apparatus 3 has a function of measuring a change of the optical path length of measurement light reflected by a measurement surface. In the third embodiment, the measurement apparatus 3 is embodied as a three-dimensional shape measurement apparatus including a non-contact probe (measurement head) using a heterodyne interference method. In the measurement apparatus 3, a measurement surface 121 is arranged (accommodated) in a chamber 715. The shape of the measurement surface 121 is measured through a light-transmissive window 710 arranged in (the wall surface of) the chamber 715. The light-transmissive window 710 is constituted by a transparent synthetic quartz substrate for a He—Ne laser having a wavelength of 633 nm. Alignment marks 711 and 712 are formed on a surface (surface closer to the measurement surface) of the light-transmissive window 710 on the inner side of the chamber 715. Alignment marks 713 and 714 are also formed on the measurement surface 121.

In the third embodiment, to measure the shape of the measurement surface 121 based on a change of the phase of measurement light, the light-transmissive window 710 is made of a material, such as synthetic quartz, excellent in optical characteristics regarding the uniformity of the refractive index distribution. These optical characteristics are a homogeneity of about 1 ppm at a wavelength of 365 nm, a birefringence of about 10 nm/cm, and a transmitted wavefront of about λ/4 at a wavelength of 633 nm.

In the measurement apparatus 3, a first processor 730 obtains a change of the light amount of measurement light based on the light amount signal of a heterodyne interference signal detected by a detector 107A. A second processor 731 obtains a change of the optical path length of measurement light based on phase information of the heterodyne interference signal detected by the detector 107A.

An interference optical system 701 constitutes a single-pass optical system, similarly to the interference optical system 103 of the measurement apparatus 1. In the measurement apparatus 3, however, a condenser lens 703 is optically designed in consideration of the optical characteristics of the light-transmissive window 710 in order to measure, through the light-transmissive window 710, the positions of the alignment marks 713 and 714 formed on the measurement surface 121. For example, the condenser lens 703 is optically designed to decrease wavefront aberration of measurement light having passed through the light-transmissive window 710. Thus, the alignment marks 713 and 714 formed on the measurement surface 121, and the alignment marks 711 and 712 formed on the light-transmissive window 710 can be irradiated with light (condensed beam) which is satisfactorily narrowed down with small wavefront aberration. When measuring the alignment marks 713 and 714 through the light-transmissive window 710, the measurement apparatus 3 can obtain a change of the light amount of measurement light more satisfactorily, compared to the case in which the interference optical system 105 of the measurement apparatus 1 is used. In other words, the positions of the alignment marks 713 and 714 formed on the measurement surface 121 can be measured satisfactorily. Similarly, the positions of the alignment marks 711 and 712 formed on the light-transmissive window 710 can be measured satisfactorily.

The measurement apparatus 3 suffices to condense measurement light on the measurement surface 121 and a surface of the light-transmissive window 710 on the measurement surface side by the autofocus system 140 using surface reflection of measurement light by the measurement surface 121 and light-transmissive window 710.

The measurement apparatus 3 measures alignment marks formed on both the measurement surface 121 and light-transmissive window 710 by using light condensed by the condenser lens 703. Therefore, the optical system needs to be adjusted to decrease wavefront aberration of light having passed through the light-transmissive window 710 in accordance with which of a surface of the light-transmissive window 710 on the measurement surface side and the surface of the interference optical system bears the alignment marks. For example, when the alignment marks 711 and 712 are formed on a surface of the light-transmissive window 710 on the measurement surface side, the condenser lens 703 is optically designed in consideration of the optical characteristics of the light-transmissive window 710, as described above. In this case, alignment marks formed on both the measurement surface 121 and light-transmissive window 710 can be measured by light (condensed beam) with small wavefront aberration. In contrast, when alignment marks are formed on a surface of the light-transmissive window 710 on the interference optical system side, an aberration correction optical system is separately used to irradiate alignment marks with satisfactory light from which the optical characteristics of the light-transmissive window 710 are removed.

In this way, the measurement apparatus 3 can measure at high precision the relative positional relationship between the interference optical system 701 and the alignment marks 711 and 712 formed on the light-transmissive window 710. Also, the measurement apparatus 3 can measure at high precision the relative positional relationship between the interference optical system 701 and the alignment marks 713 and 714 formed on the measurement surface 121. Accordingly, the relative positional relationship between the interference optical system 701, the light-transmissive window 710, and the measurement surface 121 can be grasped at high precision.

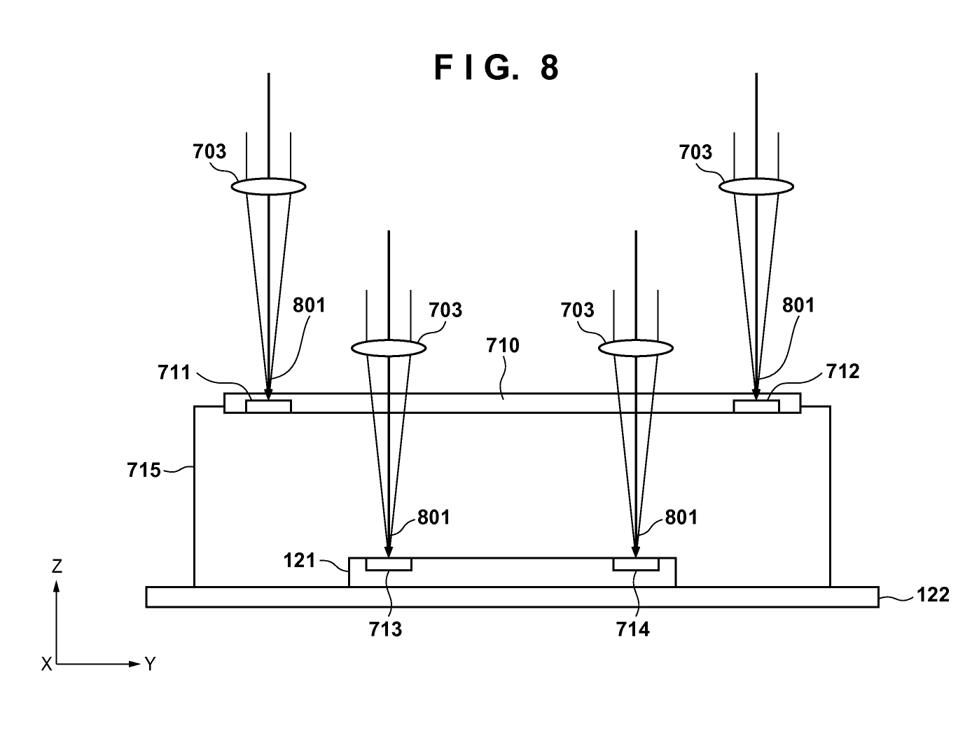

Alignment between a condensed beam 801, the alignment marks 713 and 714 formed on the measurement surface 121, and the alignment marks 711 and 712 formed on the light-transmissive window 710 will be explained with reference to FIG. 8. FIG. 8 shows a state in which the first processor 730 obtains a change of the light amount of a heterodyne interference signal while the condensed beam 801 condensed by the condenser lens 703 is moved on the alignment marks 711 and 712. Similarly, FIG. 8 shows a state in which the second processor 731 obtains a change of the light amount of heterodyne interference while the condensed beam 801 is moved on the alignment marks 713 and 714 after positions of the interference optical system 701 and condenser lens 703 in the Z-axis direction are changed.

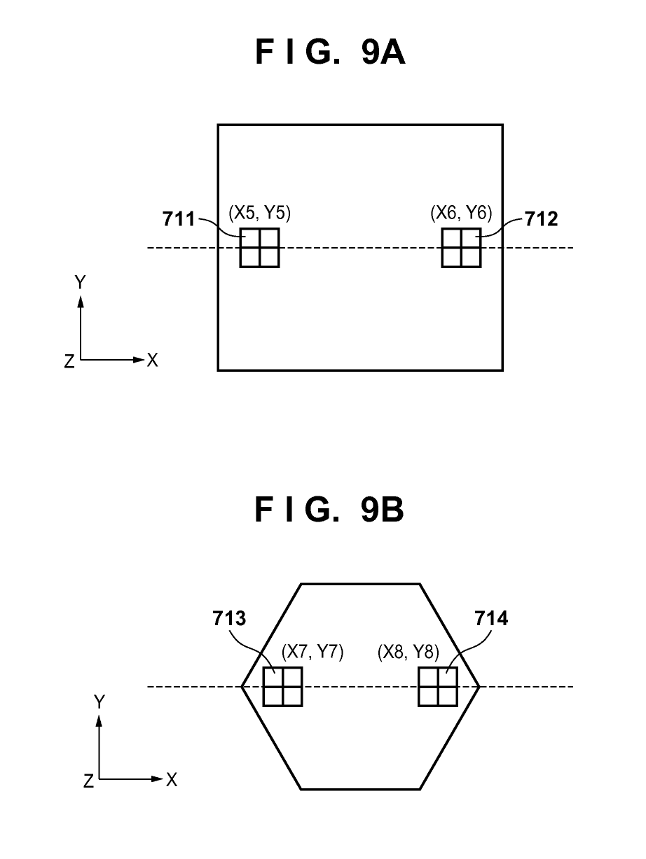

FIG. 9A is a schematic view showing the alignment marks 711 and 712 respectively formed at position coordinates (X5, Y5) and (X6, Y6) on a surface of the light-transmissive window 710 on the measurement surface side. FIG. 9B is a schematic view showing the alignment marks 713 and 714 respectively formed at position coordinates (X7, Y7) and (X8, Y8) on a surface of the measurement surface 121 on the measurement surface side. As shown in FIG. 9A, the positions (position coordinates (X5, Y5) and (X6, Y6)) of the alignment marks 711 and 712 are known on the light-transmissive window 710. Note that the alignment marks 711 and 712 can also be replaced with the edge portions of the light-transmissive window 710, as in the first embodiment. Also, as shown in FIG. 9B, the positions (position coordinates (X7, Y7) and (X8, Y8)) of the alignment marks 713 and 714 are known on the measurement surface 121.

The measurement apparatus 3 obtains the relative positional relationship between the interference optical system 701 (an interference optical system 702) including the condenser lens 703 and the positions of the four alignment marks 711 to 714. Therefore, the condensed beam 801 traveling from the interference optical system 701 can be moved to arbitrary positions on the measurement surface 121 and light-transmissive window 710 at a high precision of about several μm. When measuring an arbitrary position (measurement portion) on the measurement surface 121 with measurement light, a position of the light-transmissive window 710 at which measurement light passes (that is, the passage position of measurement light in the light-transmissive window 710) can be obtained.

In this fashion, the measurement apparatus 3 can align the interference optical system 701 including the condenser lens 703, and the measurement surface 121 at a high precision of about several μm, as in a case in which the measurement surface 121 is not arranged inside the chamber 715. Hence, a measurement error, that is, a setting error arising from an error of the installation position of the measurement surface 121 with respect to the interference optical system 701 can be reduced. Similarly to the measurement apparatus 1, the measurement apparatus 3 can greatly suppress a setting error and measure the shape of the measurement surface 121 at a high precision of about several nm RMS.

The light-transmissive window 710 generally has a thickness nonuniformity of about λ/10, that is, 63 nm. To measure the shape of the measurement surface 121 through the light-transmissive window 710 at high precision, it is necessary to grasp, on the entire measurement surface 121, a position of the light-transmissive window 710 at which measurement light passes, and correct a measurement error arising from the thickness nonuniformity of the light-transmissive window 710. According to the embodiment, a position of the light-transmissive window 710 at which measurement light passes can be obtained when an arbitrary position of the measurement surface 121 is measured. Therefore, a measurement error arising from the thickness nonuniformity of the light-transmissive window 710 can be corrected. For example, the shape of the measurement surface 121 is obtained based on a heterodyne interference signal acquired when measurement light enters a measurement portion on the measurement surface 121. An error which arises from the thickness nonuniformity of the light-transmissive window 710 and is obtained based on the positional relationship on the light-transmissive window surface between measurement light and the alignment marks 711 and 712 is removed from the obtained result. Note that the thickness nonuniformity of the light-transmissive window 710 can be measured in advance by using a transmitted wavefront measurement interferometer or the like.

As described above, the measurement apparatus 3 can grasp at high precision the relative positional relationship between the interference optical system 701 including the condenser lens 703, the light-transmissive window 710, and the measurement surface 121. The measurement apparatus 3 can reduce a measurement error, that is, a setting error arising from an error of the installation position of the measurement surface 121 with respect to the interference optical system 701. Also, the measurement apparatus 3 can reduce a measurement error arising from the thickness nonuniformity of the light-transmissive window 710. In other words, the measurement apparatus 3 can compensate for an error arising from the nonuniformity of an optical characteristic such as the thickness nonuniformity of the light-transmissive window 710. The measurement apparatus 3 can measure at high precision the shape of even the measurement surface 121 arranged inside the chamber 715.

### Fourth Embodiment

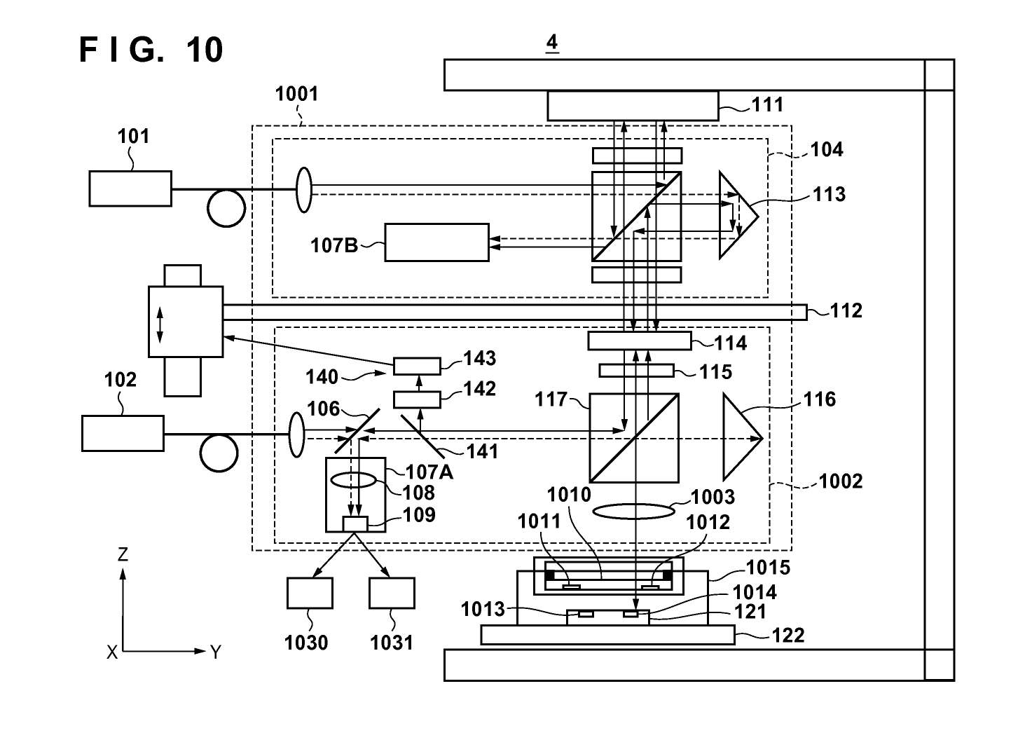

FIG. 10 is a schematic view showing the arrangement of a measurement apparatus 4 according to the fourth embodiment of the present invention. The measurement apparatus 4 has a function of measuring a change of the optical path length of measurement light reflected by a measurement surface. In the fourth embodiment, the measurement apparatus 4 is embodied as a three-dimensional shape measurement apparatus including a non-contact probe (measurement head) using a heterodyne interference method. In the measurement apparatus 4, a measurement surface 121 is arranged (accommodated) in a chamber 1015. The shape of the measurement surface 121 is measured through a light-transmissive window 1010 arranged in (the wall surface of) the chamber 1015.

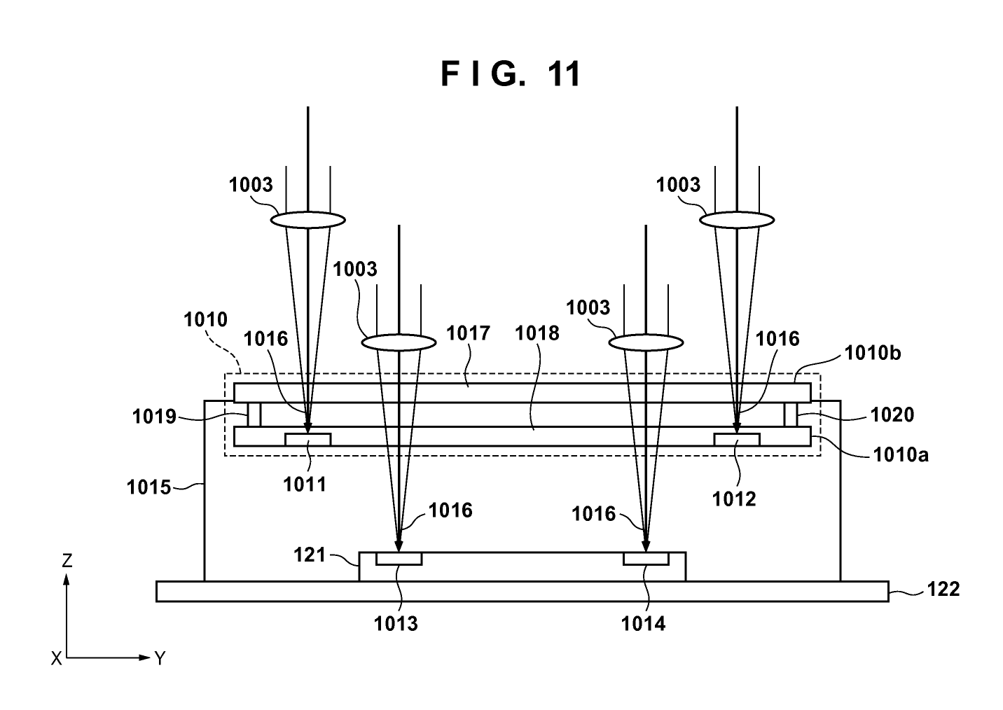

As shown in FIG. 11, the light-transmissive window 1010 includes a first light-transmissive window 1010a interposed between an interference optical system 1001 and the measurement surface 121, and a second light-transmissive window 1010b arranged on the interference optical system side with respect to the first light-transmissive window 1010a. In this manner, the light-transmissive window 1010 includes multiple light-transmissive windows on the optical path of measurement light. The first light-transmissive window 1010a and second light-transmissive window 1010b are integrated by joining members 1019 and 1020. Each of the first light-transmissive window 1010a and second light-transmissive window 1010b is constituted by a transparent synthetic quartz substrate for a He—Ne laser having a wavelength of 633 nm. Alignment marks 1011 and 1012 are formed on a surface (surface on the measurement surface side) of the first light-transmissive window 1010a on the inner side of the chamber 1015. Note that a plurality of alignment marks may be formed on each of the first light-transmissive window 1010a and second light-transmissive window 1010b. Alignment marks 1013 and 1014 are also formed on the measurement surface 121.

The measurement apparatus 4 can obtain the positional relationship between the light-transmissive window 1010 and the interference optical system 1001 by using the alignment marks 1011 and 1012 formed on the first light-transmissive window 1010a. In the measurement apparatus 4, a first processor 1030 obtains a change of the light amount of measurement light based on the light amount signal of a heterodyne interference signal detected by a detector 107A. A second processor 1031 obtains a change of the optical path length of measurement light based on phase information of the heterodyne interference signal detected by the detector 107A.

The interference optical system 1001 has the same arrangement as that of the interference optical system 103 of the measurement apparatus 1. In the measurement apparatus 4, however, a condenser lens 1003 is optically designed in consideration of the optical characteristics of the light-transmissive window 1010 in order to measure, through the light-transmissive window 1010, the alignment marks 1013 and 1014 formed on the measurement surface 121. The measurement apparatus 4 can obtain a change of the light amount of measurement light more satisfactorily, compared to a case in which the interference optical system 105 of the measurement apparatus 1 is used to measure the alignment marks 1013 and 1014 through the light-transmissive window 1010. The first processor 1030 is optimized to be able to obtain a change of the light amount of measurement light more satisfactorily when measuring the alignment marks 1013 and 1014 through the light-transmissive window 1010, compared to the first processor 130 of the measurement apparatus 1.

The measurement apparatus 4 can obtain the relative positional relationship between the interference optical system 1001 and the alignment marks 1011 and 1012 formed on the light-transmissive window 1010. Also, the measurement apparatus 4 can obtain the relative positional relationship between the interference optical system 1001 and the alignment marks 1013 and 1014 formed on the measurement surface 121. Thus, the measurement apparatus 4 can grasp the relative positional relationship between the interference optical system 1001, the light-transmissive window 1010, and the measurement surface 121 at high precision.

In the measurement apparatus 4, as in the measurement apparatus 3, an autofocus system 140 suffices to condense measurement light on surfaces of the measurement surface 121 and first light-transmissive window 1010a on the measurement surface side.

FIG. 11 shows a state in which the first processor 1030 obtains a change of the light amount of a heterodyne interference signal while a condensed beam 1016 condensed by the condenser lens 1003 is moved on the alignment marks 1011 and 1012. Similarly, FIG. 11 shows a state in which the second processor 1031 obtains a change of the light amount of heterodyne interference while the condensed beam 1016 is moved on the alignment marks 1013 and 1014 after positions of the interference optical system 1001 and condenser lens 1003 in the Z-axis direction are changed.

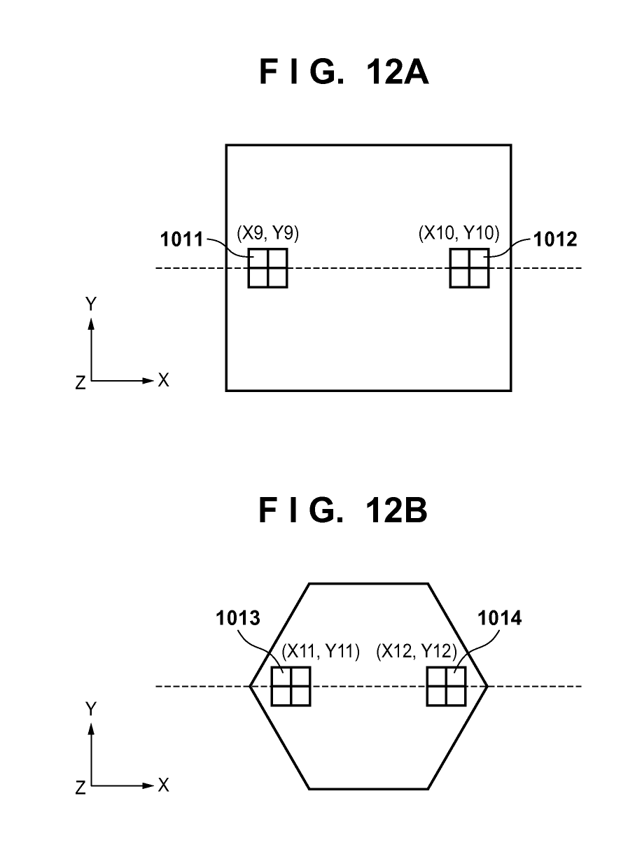

FIG. 12A is a schematic view showing the alignment marks 1011 and 1012 respectively formed at position coordinates (X9, Y9) and (X10, Y10) on a surface of the first light-transmissive window 1010a on the measurement surface side. FIG. 12B is a schematic view showing the alignment marks 1013 and 1014 respectively formed at position coordinates (X11, Y11) and (X12, Y12) on a surface of the measurement surface 121 on the measurement surface side. As shown in FIG. 12A, the positions (position coordinates (X9, Y9) and (X10, Y10)) of the alignment marks 1011 and 1012 are known on the first light-transmissive window 1010a. Similarly, as shown in FIG. 12B, the positions (position coordinates (X11, Y11) and (X12, Y12)) of the alignment marks 1013 and 1014 are known on the measurement surface 121.

The measurement apparatus 4 obtains the relative positional relationship between the interference optical system 1001 (an interference optical system 1002) including the condenser lens 1003 and the positions of the four alignment marks 1011 to 1014. The condensed beam 1016 traveling from the interference optical system 1001 can be moved to arbitrary positions on the measurement surface 121 and light-transmissive window 1010 at a high precision of about several μm. When measuring an arbitrary position (measurement portion) on the measurement surface 121 with measurement light, a position of the light-transmissive window 1010 at which measurement light passes (that is, the passage position of measurement light in the light-transmissive window 1010) can be obtained.

In this way, the measurement apparatus 4 can align the interference optical system 1001 including the condenser lens 1003, and the measurement surface 121 at a high precision of about several μm, as in a case in which the measurement surface 121 is not arranged inside the chamber 1015. Hence, a measurement error, that is, a setting error arising from an error of the installation position of the measurement surface 121 with respect to the interference optical system 1001 can be reduced. Similarly to the measurement apparatus 3, the measurement apparatus 4 can greatly suppress a setting error and measure the shape of the measurement surface 121 at a high precision of about several nm RMS.

Similarly to the measurement apparatus 3, when measuring an arbitrary position on the measurement surface 121, the measurement apparatus 4 can obtain a position of the light-transmissive window 1010 at which measurement light passes, and thus can correct a measurement error arising from the thickness nonuniformity of the light-transmissive window 1010. Note that the thickness nonuniformity of the light-transmissive window 1010 can be measured in advance by using a transmitted wavefront measurement interferometer or the like.

As described above, the measurement apparatus 4 can grasp, at high precision, the relative positional relationship between the interference optical system 1001 including the condenser lens 1003, the light-transmissive window 1010, and the measurement surface 121. The measurement apparatus 4 can reduce a measurement error, that is, a setting error arising from an error of the installation position of the measurement surface 121 with respect to the interference optical system 1001. Also, the measurement apparatus 4 can reduce a measurement error arising from the thickness nonuniformity of the light-transmissive window 1010. The measurement apparatus 4 can therefore measure at high precision the shape of the measurement surface 121 arranged inside the chamber 1015.

### Fifth Embodiment

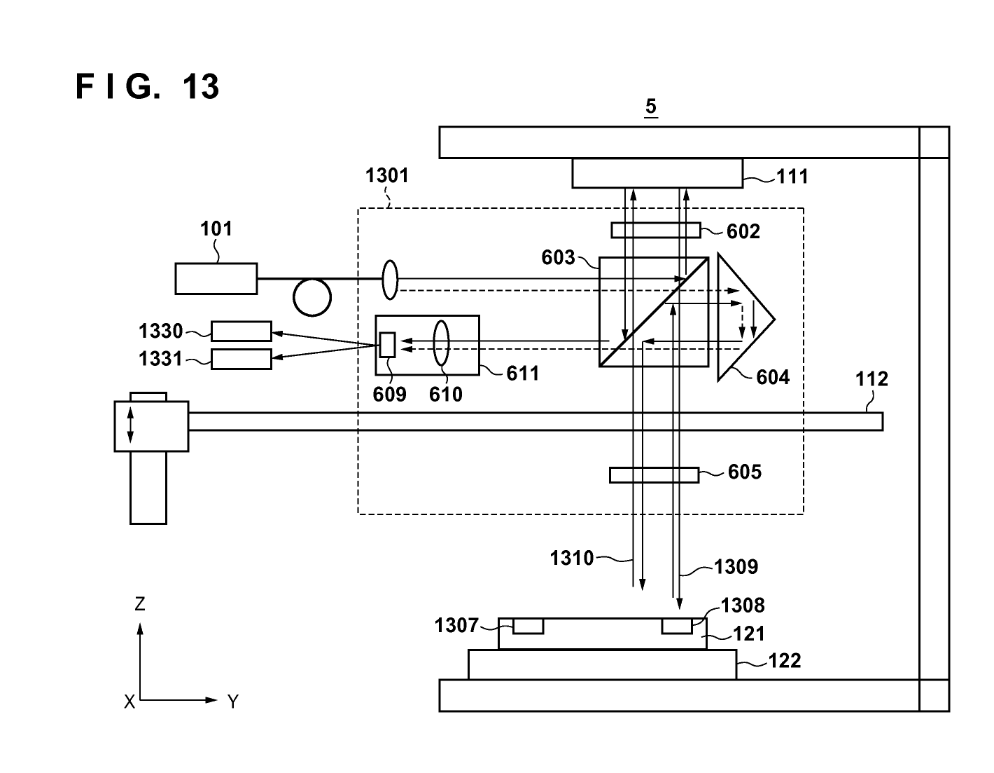

FIG. 13 is a schematic view showing the arrangement of a measurement apparatus 5 according to the fifth embodiment of the present invention. The measurement apparatus 5 has a function of measuring a change of the optical path length of measurement light reflected by a measurement surface. In the fifth embodiment, the measurement apparatus 5 is embodied as a three-dimensional shape measurement apparatus including a non-contact probe (measurement head) using a heterodyne interference method. In the measurement apparatus 5, an interference optical system 1301 is constituted as a double-pass optical system in which measurement light is reflected twice by a measurement surface 121, similarly to the interference optical system 601 of the measurement apparatus 2. In other words, the interference optical system 1301 is an optical system in which, when measuring the shape of the measurement surface 121, measurement light 1309 enters the measurement surface 121, and then measurement light 1310 having passed through a plurality of optical systems of the interference optical system 1301 enters again the measurement surface 121. The measurement apparatus 5 has a simple arrangement in which a condensing optical system such as a condenser lens 606 is not inserted in the optical path of measurement light, unlike the interference optical system 601 of the measurement apparatus 2.

Alignment marks 1307 and 1308 are formed as alignment targets on the upper surface of the measurement surface 121. Since the measurement apparatus 5 does not use the condensing optical system, measurement light on the measurement surface 121 maintains a size of 6 mm which is the diameter of parallel light emitted by a light source 101. Hence, no autofocus system need be used for alignment of measurement light in the optical axis direction with respect to the alignment marks 1307 and 1308 formed on the measurement surface 121.

In the measurement apparatus 5, a first processor 1330 obtains a change of the light amount of measurement light based on the light amount signal (intensity) of a heterodyne interference signal detected by a detector 611. A second processor 1331 obtains a change of the optical path length of measurement light based on phase information of the heterodyne interference signal detected by the detector 611.

The measurement apparatus 5 can obtain the relative positional relationship between the measurement surface 121 and the interference optical system 1301 by using the alignment marks 1307 and 1308 formed on the measurement surface 121. The measurement apparatus 5 can easily grasp the relative positional relationship between the measurement surface 121 and the interference optical system 1301 at a precision of 6 mm or less which is the diameter of parallel light.

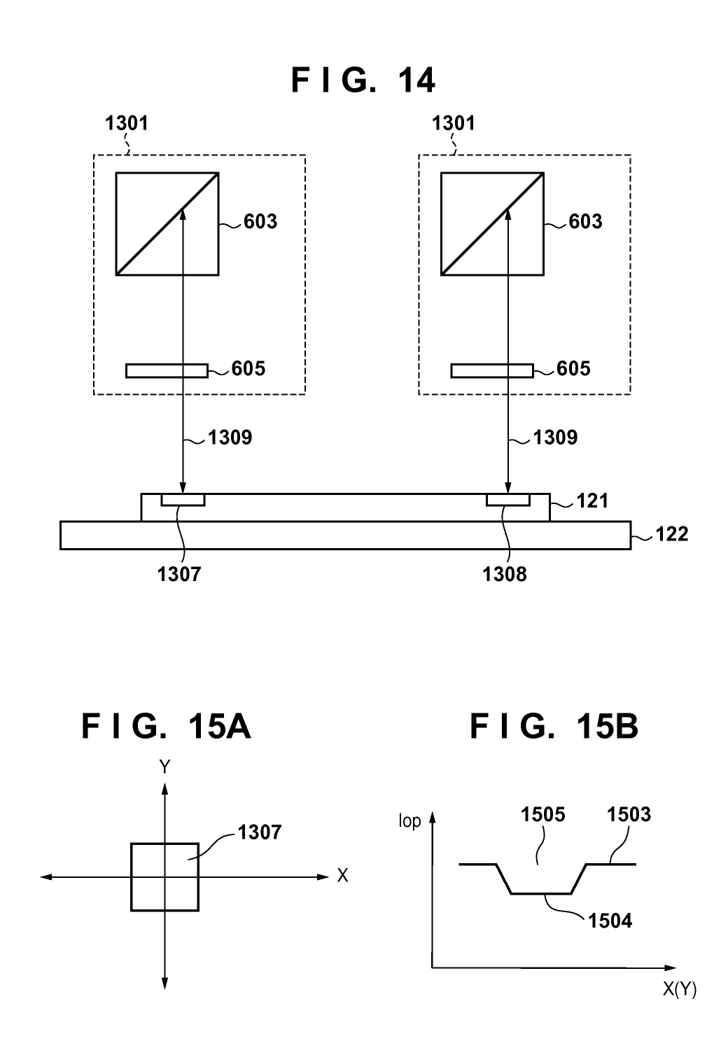

Alignment between (the measurement light 1309 from) the interference optical system 1301 and the alignment marks 1307 and 1308 formed on the measurement surface 121 will be explained with reference to FIGS. 14, 15A, and 15B. FIG. 14 shows a state in which the first processor 1330 obtains a change of the light amount of a heterodyne interference signal while the measurement beam 1309 traveling from the interference optical system 1301 is moved on the alignment marks 1307 and 1308. As light irradiating the alignment marks 1307 and 1308, the measurement light 1310 may be used instead of the measurement light 1309.

In the measurement apparatus 5, the measurement light 1309 traveling from the interference optical system 1301 can be moved to an arbitrary position in the X-Y plane by moving the interference optical system 1301 in the X-Y plane including the X-axis and Y-axis. By moving the interference optical system 1301 in the X-Y plane, each of the alignment marks 1307 and 1308 formed on the measurement surface 121 can be irradiated with the measurement light 1309. The size of the measurement light 1309 is a diameter of about 6 mm though it depends on the optical design of the light source 101.

In the measurement apparatus 5, even if the measurement surface 121 slightly shifts from a predetermined position in the Z-axis direction serving as the optical axis direction, the size of the measurement light 1309 irradiating the alignment marks 1307 and 1308 is almost equal to 6 mm which is the diameter of light emitted by the light source 101.

FIG. 15A is a schematic view showing an example of the shape of the alignment mark 1307. Since the alignment marks 1307 and 1308 have the same composition, the alignment mark 1307 will be exemplified here. In the embodiment, the alignment mark 1307 is not a 2×2-matrix mark, but is constituted by only a rectangular outer frame in consideration of 6-mmφ parallel light which irradiates the measurement surface 121. In the alignment mark 1307, for example, the rectangular outer frame is 1 mm square, the width w of a line in each of the X-axis direction and Y-axis direction is 1 mm, and the depth is about 158 nm which is equivalent to λ/4. However, the alignment mark 1307 is not limited to the rectangular outer frame.

FIG. 15B shows a light amount distribution (light amount information) 1505 obtained when the alignment mark 1307 (or 1308) formed on the measurement surface 121 is irradiated with the measurement light 1309 while the interference optical system 1301 is moved in the X-axis direction (or Y-axis direction). In FIG. 15B, the abscissa represents the position of the measurement light 1309 in the X-axis direction (or Y-axis direction) near the alignment mark 1307, and the ordinate represents a light amount Iop of the heterodyne interference signal. A light amount 1504 obtained when almost the center of the alignment mark 1307 is irradiated with the measurement light 1309 is different from a light amount 1503 obtained when the periphery of the alignment mark 1307 is irradiated with the measurement light 1309. By obtaining a light amount by the first processor 1330 while irradiating the alignment marks 1307 and 1308 with the measurement light 1309, the relative positional relationship between the measurement light 1309 and the alignment marks 1307 and 1308 can be obtained.

In the measurement apparatus 5, when the measurement light 1309 moves in, for example, the X-axis direction on the alignment mark 1307, a light amount distribution (light amount information) representing a position of the alignment mark 1307 in the X-axis direction at high precision can be acquired. Similarly, by moving the measurement light 1309 in the Y-axis direction on the alignment mark 1307, a light amount distribution (light amount information) representing a position of the alignment mark 1307 in the Y-axis direction at high precision can be acquired.

Based on the obtained positions of the alignment mark 1307 in the X-axis direction and Y-axis direction, the positional relationship in the X-Y plane between the center position of the alignment mark 1307 and the measurement light 1309 can be obtained at high precision. By optimally adjusting the size of the measurement light 1309 and the width w and depth d of the vertical line of the alignment mark 1307, the light amount distribution 1505 shown in FIG. 15B can become a light amount distribution with a higher contrast.

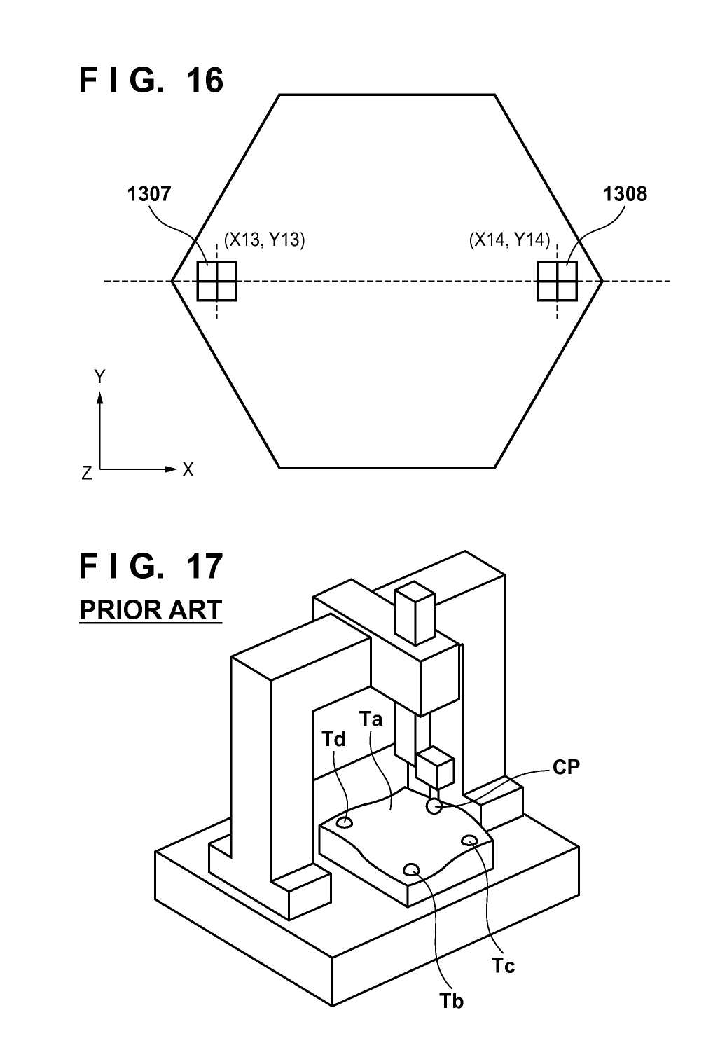

In the measurement apparatus 5, the position coordinates (X13, Y13) and (X14, Y14) of the two alignment marks 1307 and 1308 on the measurement surface 121 are known, as shown in FIG. 16. The relative positional relationship between the measurement surface 121 and the measurement light 1309, or the relative positional relationship between the measurement surface 121 and the interference optical system 1301 can be obtained at high precision on the entire measurement surface 121. Accordingly, the measurement light 1309 traveling from the interference optical system 1301 can be moved to an arbitrary position on the measurement surface 121 at high precision.

Thus, even in the measurement apparatus 5 having no condensing optical system, the interference optical system 1301 and measurement surface 121 can be aligned at high precision. A measurement error, that is, a setting error arising from an error of the installation position of the measurement surface 121 with respect to the interference optical system 1301 can be reduced. Similarly to the measurement apparatus 2, the measurement apparatus 5 can greatly suppress a setting error and measure the shape of the measurement surface 121 at high precision.

In the above-described embodiments, an alignment mark constituted by a 2×2-matrix mark, or an alignment mark constituted by a rectangular outer frame is formed on the measurement surface, and the relative positional relationship between the interference optical system and the measurement surface is obtained based on the alignment mark. However, it is also possible to form a three-dimensional shape mark as an alignment mark, and obtain the relative positional relationship between the interference optical system and the measurement surface based on a change of light amount information obtained when the alignment mark is irradiated with measurement light.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-185707 filed on Sep. 6, 2013, which is hereby incorporated by reference herein in its entirety.

What is claimed is:

1. A measurement apparatus which obtains a measurement value with respect to a measurement surface based on an interference signal obtained by causing measurement light reflected from the measurement surface and reference light reflected from a reference surface to interfere with each other, the apparatus comprising:
a measurement head including an interference optical system configured to generate the interference signal; and
a processor configured to obtain a position of an alignment target on the measurement surface based on the interference signal, and obtain the measurement value based on the position of the alignment target and the interference signal.

2. The apparatus according to claim 1, wherein the processor is configured to obtain the measurement value based on the interference signal obtained by performing alignment between the measurement surface and the measurement light based on displacement of the alignment target relative to a reference position.

3. The apparatus according to claim 1, wherein the processor is configured to obtain the measurement value based on the interference signal obtained in a state in which the alignment target is displaced relative to a reference position, and an amount of displacement of the alignment target.

4. The apparatus according to claim 1, wherein
the interference optical system includes a lens configured to focus the measurement light entering the measurement surface, and
the processor is configured to obtain the position based on the interference signal obtained by adjusting a focus state of the measurement light such that the measurement surface lies within a range of a depth of focus of the lens.

5. The apparatus according to claim 1, further comprising a chamber including a light-transmissive window for transmitting the measurement light and configured to accommodate the measurement surface,
wherein the processor is configured to obtain a position of an alignment target on the light-transmissive window based on the interference signal, and obtain the measurement value further based on the position of the alignment target on the light-transmissive window.

6. The apparatus according to claim 5, wherein the processor is configured to compensate for an error of the measurement value due to non-uniformity of an optical characteristic of the light-transmissive window based on displacement of the alignment target on the light-transmissive window relative to a reference position.

7. The apparatus according to claim 5, wherein the alignment target is included in a surface, of the light-transmissive window, that is closer to the measurement surface than the other surface thereof.

8. The apparatus according to claim 5, wherein the alignment target includes an edge portion of the light-transmissive window.

9. The apparatus according to claim 5, wherein the alignment target includes an alignment mark formed on the light-transmissive window.

10. The apparatus according to claim 5, wherein the light-transmissive window includes multiple light-transmissive windows on an optical path of the measurement light.

11. The apparatus according to claim 1, wherein the alignment target on the measurement surface includes an alignment mark formed on the measurement surface.

12. The apparatus according to claim 1, wherein the alignment target on the measurement surface includes an edge portion of the measurement surface.

13. The apparatus according to claim 1, wherein the processor is configured to obtain, as the measurement value, a value related to a shape of the measurement surface.
